(19) United States
(12) Patent Application Publication
(10) Pub. No.: US 2010/0320150 A1
(43) Pub. Date: Dec. 23, 2010

(54) LIQUID FILTRATION

(76) Inventor: Paul Dagesse, Beaverlodge (CA)

Correspondence Address: ADE & COMPANY INC., 2157 Henderson Highway, WINNIPEG, MB, R2G1P9, CA

(21) Appl. No.: 12/784,229

(22) Filed: May 20, 2010

Related U.S. Application Data
(60) Provisional application No. 61/219,047, filed on Jun. 22, 2009.

(51) Int. Cl. B01D 39/14; B01D 37/00; B01D 15/04

(52) U.S. Cl. 210/663; 210/767; 210/486

(57) ABSTRACT

Contaminated water is filtered by passing through a mat formed from strips of material arranged side by side and connected at spaced positions longitudinally to define a honeycomb structure with top and bottom surfaces of the mat defined by edges of the strips with the top and bottom edges covered by cover sheet bonded to the edges of the strips. At least some of the cells are at least partly filled with a particulate water filtration medium such as zeolite.

This application claims the benefit under 35 U.S.C. 119 of Provisional Application Ser. No. 61/219,047 filed Jun. 22, 2009.

This invention relates to a method and apparatus for filtration of liquid containing contaminants to be extracted and particularly to a water filtration system.

### BACKGROUND OF THE INVENTION

International Application 2006/047812 published May 11, 2006 by Tumbers discloses a method for treating water comprising the steps of: (a) filtering the water through a filter medium comprising a primary media selected from the group consisting of zeolites and clays and combinations thereof, a secondary media selected from the group consisting of carbonaceous materials and a tertiary media selected from the group consisting of inorganic calcium containing materials; and (b) sanitising the water with an essential oil.

### SUMMARY OF THE INVENTION

It is one object of the present invention to provide a method of filtration which uses an alternative support construction for the filtration medium.

According to one aspect of the invention there is provided a method of water filtration comprising:

providing a mat formed from strips of material arranged side by side and connected at spaced positions longitudinally of the strips so that each strip is connected to a next adjacent strip on one side at first spaced positions and to a next adjacent strip on an opposed side at second spaced positions which are arranged alternately to the first spaced positions so as to form a honeycomb structure with first and second surfaces of the mat defined by edges of the strips;

the mat therefore having tubular cells extending between the first and second surfaces of the mat defined between the strips

covering the first surface of the mat with a first cover sheet bonded to the edges strip at the first surface so as to close the cells at the first surface;

covering the second surface of the mat with a second cover sheet bonded to the edges strip at the second surface so as to close the cells at the second surface;

and arranging the mat so that water requiring filtration from a water supply passes through the cells.

The water may be contaminated by many different materials requiring filtration including oil, sewage and various chemicals or metals.

In most cases at least some of the cells are at least partly filled with a particulate water filtration medium such as zeolite or other alternative similar materials.

Preferably the cells are empty apart from the filtration medium.

Preferably the mat is arranged such that the water passes through the first sheet and exits through the second sheet.

Preferably the mat is supported by a support member butting at least the bottom sheet.

Preferably the mat is formed wholly by the strips and the top and bottom sheets.

Preferably the strips and/or the sheets are formed of a non-woven fibrous material.

Preferably the strips and/or the sheets are formed of a spun bond fibrous plastics material.

Preferably the strips and/or the sheets are porous.

Preferably the strips and/or the sheets are connected together by heat bonding.

According to a second aspect of the invention there is provided a filtration apparatus comprising:

a mat formed from strips of material arranged side by side and connected at spaced positions longitudinally of the strips so that each strip is connected to a next adjacent strip on one side at first spaced positions and to a next adjacent strip on an opposed side at second spaced positions which are arranged alternately to the first spaced positions so as to form a honeycomb structure with first and second surfaces of the mat defined by edges of the strips;

the mat therefore having tubular cells extending between the first and second surfaces of the mat defined between the strips

a first cover sheet covering the first surface of the mat and bonded to the edges strip at the first surface so as to close the cells at the first surface;

a second cover sheet covering the second surface of the mat and bonded to the edges strip at the second surface so as to close the cells at the second surface;

wherein at least some of the cells are at least partly filled with a particulate filtration medium.

While the term “honeycomb” is used generally and in this document it will be appreciated that the tubular cells formed are generally not accurately hexagonal in cross section, particularly where, as described herein, the cells are formed from a porous fibrous material without reinforcing resin available during the filling process to maintain a regular shape of the cells.

### BRIEF DESCRIPTION OF THE DRAWINGS

One embodiment of the invention will now be described in conjunction with the accompanying drawings in which:

FIG. 1 is an isometric view of a filter mat to be used in the present invention.

FIG. 2 is a cross sectional view along the lines 2-2 of FIG. 1.

In the drawings like characters of reference indicate corresponding parts in the different figures.

### DETAILED DESCRIPTION

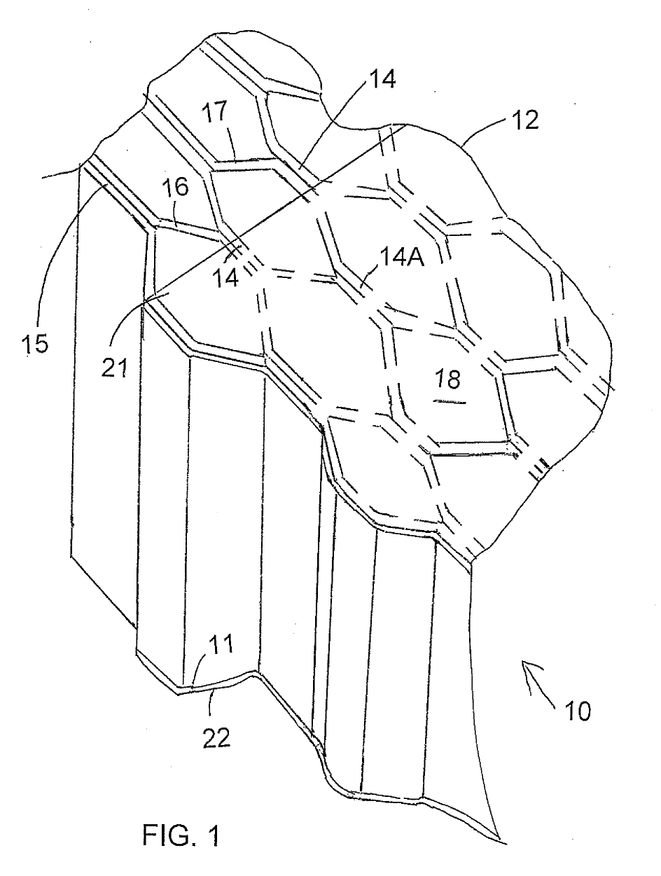

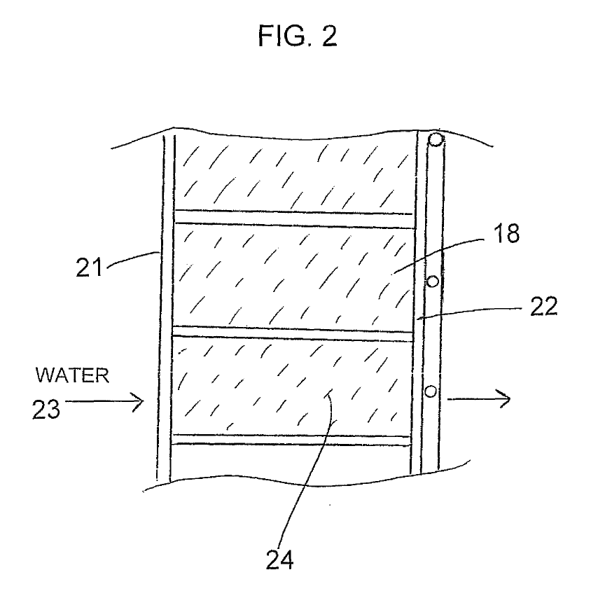

The mat described in general above is shown in FIGS. 1 and 2 and is formed by a honeycomb core panel 10 having a first face 11 and a second opposite face 12 with an array of generally hexagonal tubular cells 18 defined by walls 10A of the core panel extending between the first and second faces. The cells are formed from a row of strips 15, 16 arranged side by side formed of a porous fibrous material which is heat sealed at a sealing line 14 to define the generally hexagonal cells.

More particularly the strips of material 15, 16 etc arranged side by side are connected at spaced positions 14, 14A longitudinally of the strips so that each strip 16 is connected to a next adjacent strip 15 on one side at first spaced positions 14A and to a next adjacent strip 17 on an opposed side at second spaced positions 14 which are arranged alternately to the first spaced positions 14A so as to form a honeycomb structure with top and bottom surfaces 11 and 12 of the mat defined by edges of the strips.

The strips are connected together at connections 14 and 14A preferably by heat bonding since this does not affect the properties of the product at the connection line and particularly leaves the product flexible and compressible.

The top and bottom surfaces 11 and 12 are covered with a respective cover sheet 21 and 22 bonded to the edges strip at the top surface so as to close the cells.

The strips and the sheets are formed of a non-woven fibrous material such as a spun bond fibrous plastics material so that the strips are porous.

As shown in FIG. 2, the mat is arranged so that water 23 requiring filtration from a water supply passes through the cells so that it enters through the top sheet and exits through the bottom sheet.

At least some of the cells are at least partly filled with a particulate water filtration medium 24 such as zeolite. The cells and the cover sheets act to support and contain the filtration medium so that it allows the contaminated liquid to effectively pass through without allowing the generation of open locations where the liquid can pass though the structure without engaging the filtration medium.

The mat so formed can be in the order of 4 feet to 8 feet wide with a length which can be 40 feet or longer. The cells typically can have a diameter (or transverse dimension of the order of ⅜ inch to 6 inches and a depth, that is, the width of the strips which is typically ½ inch to 8 inches but can be much longer if required to carry more filtration medium.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of filtration of a contaminated liquid comprising:
providing a mat formed from strips of material arranged side by side and connected at spaced positions longitudinally of the strips so that each strip is connected to a next adjacent strip on one side at first spaced positions and to a next adjacent strip on an opposed side at second spaced positions which are arranged alternately to the first spaced positions so as to form a honeycomb structure with first and second surfaces of the mat defined by edges of the strips;
the mat therefore having tubular cells extending between the first and second surfaces of the mat defined between the strips
covering the first surface of the mat with a first cover sheet bonded to the edges strip at the first surface so as to close the cells at the first surface;
covering the second surface of the mat with a second cover sheet bonded to the edges strip at the second surface so as to close the cells at the second surface;
and arranging the mat so that contaminated liquid requiring filtration from a supply passes through the cells.

2. The method according to claim 1 wherein at least some of the cells are at least partly filled with a particulate filtration medium.

3. The method according to claim 2 wherein the filtration medium is zeolite.

4. The method according to claim 2 wherein the cells are empty apart from the filtration medium.

5. The method according to claim 1 wherein the mat is arranged such that the contaminated liquid passes through the first sheet and exits through the second sheet.

6. The method according to claim 1 wherein the mat is supported by a support member butting at least the second sheet.

7. The method according to claim 1 wherein the mat is formed wholly by the strips and the first and second sheets.

8. The method according to claim 1 wherein the strips are formed of a non-woven fibrous material.

9. The method according to claim 1 wherein the strips are formed of a spun bond fibrous plastics material.

10. The method according to claim 1 wherein the strips are porous.

11. The method according to claim 1 wherein the strips are connected together by heat bonding.

12. The method according to claim 1 wherein the sheets are formed of a non-woven fibrous material.

13. The method according to claim 1 wherein the sheets are formed of a spun bond fibrous plastics material.

14. The method according to claim 1 wherein the sheets are porous.

15. The method according to claim 1 wherein the sheets are connected to the strips by heat bonding.

16. A filtration apparatus comprising:
a mat formed from strips of material arranged side by side and connected at spaced positions longitudinally of the strips so that each strip is connected to a next adjacent strip on one side at first spaced positions and to a next adjacent strip on an opposed side at second spaced positions which are arranged alternately to the first spaced positions so as to form a honeycomb structure with first and second surfaces of the mat defined by edges of the strips;
the mat therefore having tubular cells extending between the first and second surfaces of the mat defined between the strips
a first cover sheet covering the first surface of the mat and bonded to the edges strip at the first surface so as to close the cells at the first surface;
a second cover sheet covering the second surface of the mat and bonded to the edges strip at the second surface so as to close the cells at the second surface;
wherein at least some of the cells are at least partly filled with a particulate filtration medium.

17. The apparatus according to claim 16 wherein the filtration medium is zeolite.

18. The apparatus according to claim 16 wherein the cells are empty apart from the filtration medium.

19. The apparatus according to claim 16 wherein the mat is supported by a support member butting at least the second sheet such that the contaminated liquid passes through the first sheet and exits through the second sheet.

20. The apparatus according to claim 16 wherein the strips and the sheets are formed of a non-woven fibrous material.

21. The apparatus according to claim 16 wherein the strips are connected together and connected to the sheets by heat bonding.
